(19) United States
(12) Patent Application Publication
(10) Pub. No.: US 2024/0364125 A1
(43) Pub. Date: Oct. 31, 2024

(54) BATTERY PACK AND METHOD FOR CONTROLLING THE SAME

(71) Applicant: MURATA MANUFACTURING CO., LTD., Kyoto (JP)

(72) Inventor: Keisuke SAITO, Kyoto (JP)

(21) Appl. No.: 18/597,052

(22) Filed: Mar. 6, 2024

(30) Foreign Application Priority Data
Apr. 27, 2023 (JP) 2023-073475

(51) Int. Cl. H02J 7/00; H01M 10/42; H01M 10/48; H01M 50/581

(52) U.S. Cl. CPC H02J 7/0031; H01M 10/4257; H01M 10/486; H01M 50/581; H01M 2200/103

(57) ABSTRACT

A battery pack that can cut off its charge/discharge path in various states in which a battery pack should not be used is obtained. A battery pack according to an embodiment of the present disclosure includes: a secondary battery provided on a path connecting a first terminal and a second terminal and having a plurality of battery cells; a monitoring circuit capable of detecting a cell voltage of each of the plurality of battery cells; a first connection terminal led to the first terminal via a first path; a second connection terminal led to the second terminal via a second path; a fuse element provided on the first path; a heat generator provided on a third path connecting the first path and the second path and capable of melting and cutting the fuse element; a switch element provided on the third path; and a control circuit capable of controlling a switching operation of the switch element based on a detection result of the monitoring circuit, by performing PFM control such that the switch element has an ON time that is kept at a predetermined time and the switch element has an OFF time that can be changed according to a secondary battery voltage.

### CROSS REFERENCE TO RELATED APPLICATIONS

The present application claims priority to Japanese patent application no. 2023-073475, filed on Apr. 27, 2023, the entire contents of which are incorporated herein by reference.

### BACKGROUND

The present disclosure relates to a battery pack including a secondary battery, and a method for controlling a battery pack used in such a battery pack.

A battery pack including a secondary battery cuts off its charge/discharge path, for example, when the secondary battery is overcharged.

For example, a technique discloses melting and cutting a fuse element provided on a charge/discharge path in an overcharged state.

### SUMMARY

It is desirable that a battery pack cuts off its charge/discharge path not only in an overcharged state, but also in other various states in which a battery pack should not be used.

It is desirable to provide a battery pack and a method for controlling a battery pack that can cut off its charge/discharge path in various states in which a battery pack should not be used.

A battery pack according to an embodiment of the present disclosure includes a secondary battery, a monitoring circuit, a first connection terminal, a second connection terminal, a fuse element, a heat generator, a switch element, and a control circuit. The secondary battery is provided on a path connecting a first terminal and a second terminal and has a plurality of battery cells connected in series. The monitoring circuit can detect a cell voltage of each of the plurality of battery cells. The first connection terminal is led to the first terminal via a first path. The second connection terminal is led to the second terminal via a second path. The fuse element is provided on the first path and can be melted and cut due to heat. The heat generator is provided on a third path connecting the first path and the second path and can generate heat to melt and cut the fuse element. The switch element is provided on the third path. The control circuit can control a switching operation of the switch element based on a detection result of the monitoring circuit, by performing PFM control such that the switch element has an ON time that is kept at a predetermined time and the switch element has an OFF time that can be changed according to a secondary battery voltage, which is a voltage between both terminals of the secondary battery.

A method for controlling a battery pack according to an embodiment of the present disclosure, the battery pack including: a secondary battery provided on a path connecting a first terminal and a second terminal and having a plurality of battery cells connected in series; a first connection terminal led to the first terminal via a first path; a second connection terminal led to the second terminal via a second path; a fuse element provided on the first path and configured to be melted and cut due to heat; a heat generator provided on a third path connecting the first path and the second path and capable of generating heat to melt and cut the fuse element; and a switch element provided on the third path, includes detecting a cell voltage of each of the plurality of battery cells; and controlling an operation of the switch element based on a plurality of the detected cell voltages by performing PFM control such that the switch element has an ON time that is kept at a predetermined time and has an OFF time that can be changed according to a secondary battery voltage, which is a voltage between both terminals of the secondary battery.

According to an embodiment of the present disclosure, the battery pack and the method for controlling a battery pack can cut off its charge/discharge path in various states in which a battery pack should not be used.

### BRIEF DESCRIPTION OF THE FIGURES

FIG. 1 is a block diagram illustrating a configuration example of a battery pack according to an embodiment of the present disclosure;

FIG. 2 is an explanatory diagram illustrating a characteristic example of a battery cell illustrated in FIG. 1;

FIG. 3 is a waveform diagram illustrating an example of the waveform of a control signal illustrated in FIG. 1;

FIG. 4 is a flowchart showing an operation example of a control circuit illustrated in FIG. 1;

FIG. 5 is an explanatory diagram illustrating an example of the voltage range of a secondary battery voltage;

FIG. 6 is a characteristic table showing a characteristic example of a protection circuit illustrated in FIG. 1;

FIG. 7 is a characteristic graph showing a characteristic example of a protection circuit illustrated in FIG. 1;

FIG. 8 is another waveform diagram illustrating an example of the waveform of a control signal illustrated in FIG. 1;

FIG. 9 is another characteristic table showing a characteristic example of a protection circuit illustrated in FIG. 1;

FIG. 10 is another characteristic graph showing a characteristic example of a protection circuit illustrated in FIG. 1;

FIG. 11 is another characteristic table showing a characteristic example of a protection circuit illustrated in FIG. 1;

FIG. 12 is a flowchart showing a procedure for determining PFM control parameters;

FIG. 13 is a waveform diagram illustrating an example of the waveform of a control signal when PWM control is performed;

FIG. 14 is a characteristic table showing a characteristic example of a protection circuit when PWM control is performed;

FIG. 15A is a circuit diagram illustrating an example of a protection circuit illustrated in FIG. 1;

FIG. 15B is a circuit diagram illustrating an example of a protection circuit according to an embodiment;

FIG. 15C is a circuit diagram illustrating an example of a protection circuit according to an embodiment; and

FIG. 16 is a block diagram illustrating a configuration example of a battery pack according to an embodiment.

### DETAILED DESCRIPTION

The present disclosure will be described below in further detail including with reference to the drawings according to an embodiment.

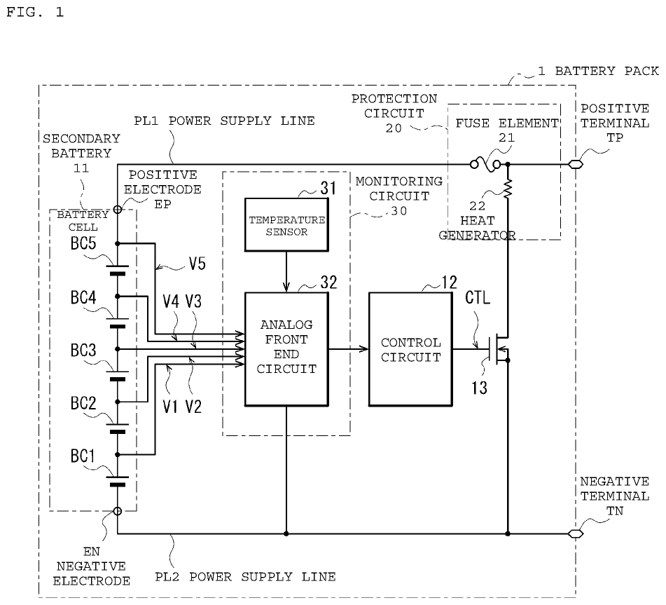

FIG. 1 illustrates a configuration example of a battery pack (battery pack 1) according to an embodiment. The battery pack 1 includes a positive terminal TP, a negative terminal TN, a secondary battery 11, a protection circuit 20, a monitoring circuit 30, a control circuit 12, and a transistor 13.

The positive terminal TP and the negative terminal TN are configured to electrically connect the battery pack 1 and a device to which the battery pack 1 is attached. The device may be, for example, a charger that supplies power to the battery pack 1 or a load device that operates based on the power of the battery pack 1. The positive terminal TP is led to a positive electrode EP of the secondary battery 11 via a power supply line PL1. Here, the term “led” includes not only a case where the positive terminal TP is connected to the positive electrode EP of the secondary battery 11 via the protection circuit 20 as illustrated in FIG. 1, but also includes a case of being connected further via a switch, a resistance element, or the like (not illustrated), for example. The negative terminal TN is led to a negative electrode EN of the secondary battery 11 via a power supply line PL2. Here, the term “led” includes not only a case where the negative terminal TN is directly connected to the negative electrode EN of the secondary battery 11 as illustrated in FIG. 1, but also includes a case of being connected further with, for example, a switch, a resistance element, or the like (not illustrated) interposed therebetween.

The secondary battery 11 is configured to store power. For example, when the battery pack 1 is connected to a charger, a charge current flows through the positive terminal TP, the protection circuit 20, the secondary battery 11, and the negative terminal TN in this order, whereby the secondary battery 11 is charged. When the battery pack 1 is connected to a load device, a discharge current flows through the negative terminal TN, the secondary battery 11, the protection circuit 20, and the positive terminal TP in this order, whereby the secondary battery 11 is discharged.

The secondary battery 11 includes a plurality of battery cells BC (in this example, five battery cells BC1 to BC5). Each of the battery cells BC1 to BC5 is configured using a lithium ion secondary battery in this example. The battery cells BC1 to BC5 are connected in series. Specifically, the positive electrode of the battery cell BC1 is connected to the negative electrode of the battery cell BC2, and the negative electrode is connected to the negative electrode EN of the secondary battery 11. The positive electrode of the battery cell BC2 is connected to the negative electrode of the battery cell BC3, and the negative electrode is connected to the positive electrode of the battery cell BC1. The positive electrode of the battery cell BC3 is connected to the negative electrode of the battery cell BC4, and the negative electrode is connected to the positive electrode of the battery cell BC2. The positive electrode of the battery cell BC4 is connected to the negative electrode of the battery cell BC5, and the negative electrode is connected to the positive electrode of the battery cell BC3. The positive electrode of the battery cell BC5 is connected to the positive electrode EP of the secondary battery 11, and the negative electrode is connected to the positive electrode of the battery cell BC4.

The cell voltage VBC of the battery cell BC is the voltage between the positive electrode and the negative electrode of the battery cell BC. Specifically, the cell voltage VBC1 of the battery cell BC1 is the voltage between the positive electrode and the negative electrode of the battery cell BC1. The cell voltage VBC2 of the battery cell BC2 is the voltage between the positive electrode and the negative electrode of the battery cell BC2. The cell voltage VBC3 of the battery cell BC3 is the voltage between the positive electrode and the negative electrode of the battery cell BC3. The cell voltage VBC4 of the battery cell BC4 is the voltage between the positive electrode and the negative electrode of the battery cell BC4. The cell voltage VBC5 of the battery cell BC5 is the voltage between the positive electrode and the negative electrode of the battery cell BC5. The cell voltage VBC can change according to the storage amount in the battery cell BC.

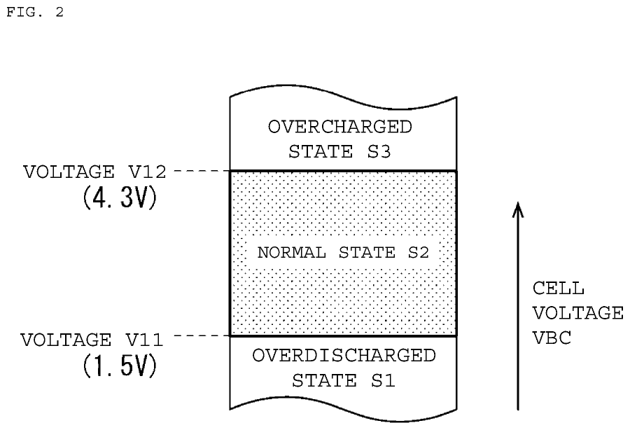

FIG. 2 illustrates an example of the cell voltage VBC. When the cell voltage VBC is equal to or higher than a voltage V11 (1.5 [V] in this example) and equal to or lower than a voltage V12 (4.3 [V] in this example), the battery cell BC is in a normal state S2 and is in a usable state. For example, when the cell voltage VBC is higher than the voltage V12, the battery cell BC is in an overcharged state S3 and cannot be used. For example, when the cell voltage VBC is lower than the voltage V11, the battery cell BC is in an overdischarged state S1 and cannot be used. In the battery pack 1, each of the five cell voltages VBC1 to VBC5 of the five battery cells BC1 to BC5 is monitored by the monitoring circuit 30.

The protection circuit 20 is provided on the power supply line PL1 and is configured to be able to cut off the charge/discharge path of the secondary battery 11. The protection circuit 20 includes a fuse element 21 and a heat generator 22. In this example, the protection circuit 20 is housed in one package. Note that the protection circuit 20 is not limited thereto, and may be a combination of separated components. The fuse element 21 is provided on the power supply line PL1 and is configured to be melted and cut by the heat of the heat generator 22. One end of the fuse element 21 is connected to the positive electrode EP of the secondary battery 11, and the other end of the fuse element 21 is connected to the positive terminal TP of the battery pack 1. The heat generator 22 is provided on a path connecting the power supply line PL1 and the power supply line PL2, and is configured to generate heat according to a current flowing through the heat generator 22. One end of the heat generator 22 is connected to the positive terminal TP, and the other end of the heat generator 22 is connected to the drain of the transistor 13.

The monitoring circuit 30 is configured to monitor the cell voltages VBC1 to VBC5 of the battery cells BC1 to BC5 in the secondary battery 11 and the temperature of the secondary battery 11. The monitoring circuit 30 includes a temperature sensor 31 and an analog front end circuit 32.

The temperature sensor 31 includes, for example, a thermistor, and is configured to detect the temperature of the secondary battery 11. The temperature sensor 31 is provided, for example, near the secondary battery 11 and detects the temperature of the secondary battery 11. Then, the temperature sensor 31 provides a detection result to the analog front end circuit 32.

The analog front end circuit 32 is configured to detect the voltages V1 to V5 of the secondary battery 11 based on the voltage of the power supply line PL2, thereby detecting the cell voltages VBC1 to VBC5 of the battery cells BC1 to BC5, and provide the detection result to the control circuit 12 together with the detection result of the temperature sensor 31.

The control circuit 12 is configured using, for example, a microcontroller, and is configured to determine whether to stop using the battery pack 1 based on the detection result of the monitoring circuit 30. Specifically, for example, the control circuit 12 makes a decision to stop using the battery pack 1, for example, when one or more of the battery cells BC1 to BC5 in the secondary battery 11 is in the overcharged state S3, when one or more of the battery cells BC1 to BC5 in the secondary battery 11 is in the overdischarged state S1, when the temperature of the secondary battery 11 is a temperature that is out of a predetermined temperature range, or when the monitoring circuit 30 is not normally operating. When it is required to stop using the battery pack 1, the control circuit 12 performs pulse frequency modulation (PFM) control based on the voltage (secondary battery voltage VB) between the positive electrode EP and the negative electrode EN of the secondary battery 11 and thereby generates a control signal CTL. The control circuit 12 controls the switching operation of the transistor 13 by using the control signal CTL. In the PFM control, the control circuit 12 has the transistor 13 have an ON time Ton that is kept at a predetermined time and has the transistor 13 have an OFF time Toff that can be changed according to the voltage (secondary battery voltage VB) between the positive electrode EP and the negative electrode EN in the secondary battery 11.

The transistor 13 is configured to perform a switching operation based on the control signal CTL. The transistor 13 is an N-type field effect transistor (FET) in this example, the gate thereof is provided with the control signal CTL, the drain thereof is connected to the other end of the heat generator 22, and the source thereof is connected to the power supply line PL2.

In the battery pack 1 having the configuration, the control circuit 12 performs the PFM control to generate the control signal CTL, thereby the heat generator 22 consumes power corresponding to the duty ratio of the control signal CTL and generates heat. Then, the fuse element 21 is melted and cut by the heat of the heat generator 22. In this way, the battery pack 1 irreversibly cuts off the charge/discharge path when it is required to stop using the battery pack 1.

Here, the secondary battery 11 corresponds to a specific example of the “secondary battery” in an embodiment of the present disclosure. The battery cells BC1 to BC5 correspond to a specific example of the “a plurality of battery cells” in an embodiment of the present disclosure. The positive electrode EP corresponds to a specific example of the “first terminal” in an embodiment of the present disclosure. The negative electrode EN corresponds to a specific example of the “second terminal” in an embodiment of the present disclosure. The monitoring circuit 30 corresponds to a specific example of the “monitoring circuit” in an embodiment of the present disclosure. The positive terminal TP corresponds to a specific example of the “first connection terminal” in an embodiment of the present disclosure. The power supply line PL1 corresponds to a specific example of the “first path” in an embodiment of the present disclosure. The negative terminal TN corresponds to a specific example of the “second connection terminal” in an embodiment of the present disclosure. The power supply line PL2 corresponds to a specific example of the “second path” in an embodiment of the present disclosure. The fuse element 21 corresponds to a specific example of the “fuse element” in an embodiment of the present disclosure. The heat generator 22 corresponds to a specific example of the “heat generator” in an embodiment of the present disclosure. The transistor 13 corresponds to a specific example of the “switch element” in an embodiment of the present disclosure. The control circuit 12 corresponds to a specific example of the “control circuit” in an embodiment of the present disclosure. The voltage V12 corresponds to a specific example of the “first threshold voltage” in an embodiment of the present disclosure. The voltage V11 corresponds to a specific example of the “second threshold voltage” in an embodiment of the present disclosure.

Next, the operation and effects of the battery pack 1 of will be described according to an embodiment.

First, the summary of the overall operation of the battery pack 1 will be described with reference to FIG. 1. The secondary battery 11 stores power. The monitoring circuit 30 monitors the cell voltages VBC1 to VBC5 of the battery cells BC1 to BC5 and the temperature of the secondary battery 11. The control circuit 12 determines whether to stop using the battery pack 1 based on the detection result of the monitoring circuit 30. When it is required to stop using the battery pack 1, the control circuit 12 performs the PFM control based on the secondary battery voltage VB and thereby generates a control signal CTL. The control circuit 12 controls the switching operation of the transistor 13 by using the control signal CTL. The transistor 13 performs a switching operation based on the control signal CTL. The heat generator 22 generates heat by consuming power corresponding to the duty ratio of the control signal CTL, and the fuse element 21 is melted and cut due to heat from the heat generator 22.

For example, the control circuit 12 makes a decision to stop using the battery pack 1, for example, when one or more of the battery cells BC1 to BC5 in the secondary battery 11 is in the overcharged state S3, when one or more of the battery cells BC1 to BC5 in the secondary battery 11 is in the overdischarged state S1, when the temperature of the secondary battery 11 is a temperature that is out of a predetermined temperature range, or when the monitoring circuit 30 is not normally operating. When it is required to stop using the battery pack 1, the control circuit 12 performs the PFM control based on the secondary battery voltage VB and thereby generates a control signal CTL. The transistor 13 performs a switching operation based on the control signal CTL.

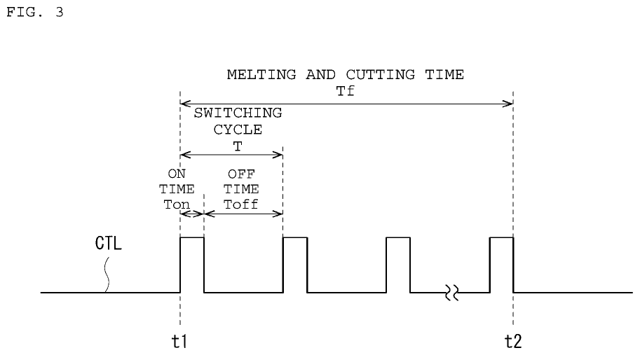

FIG. 3 illustrates an example of the control signal CTL. In the PFM control, the control circuit 12 has the transistor 13 have an ON time Ton that is kept at a predetermined time and has the transistor 13 have an OFF time Toff that can be changed according to the secondary battery voltage VB. Specifically, for example, when the secondary battery voltage VB is high, the control circuit 12 increases the OFF time Toff while maintaining the ON time Ton, thereby increasing the switching cycle T and decreasing the duty ratio. Here, the duty ratio is the ratio of the ON time Ton in the switching cycle T. In addition, for example, when the secondary battery voltage VB is low the control circuit 12 decreases the OFF time Toff while maintaining the ON time Ton, thereby decreasing the switching cycle T and increasing the duty ratio. In this manner, the control circuit 12 adjusts the power consumed in the heat generator 22 by adjusting the duty ratio based on the secondary battery voltage VB, thereby adjusting the calorific value in the heat generator 22. Then, the fuse element 21 is melted and cut by the heat from the heat generator 22, and the charge/discharge path is irreversibly cut off. When the fuse element 21 is melted and cut, the control circuit 12 ends the PFM control. The time from the timing t1 at which the PFM control is started to the timing t2 at which the PFM control is ended is the melting and cutting time Tf required to melt and cut the fuse element 21.

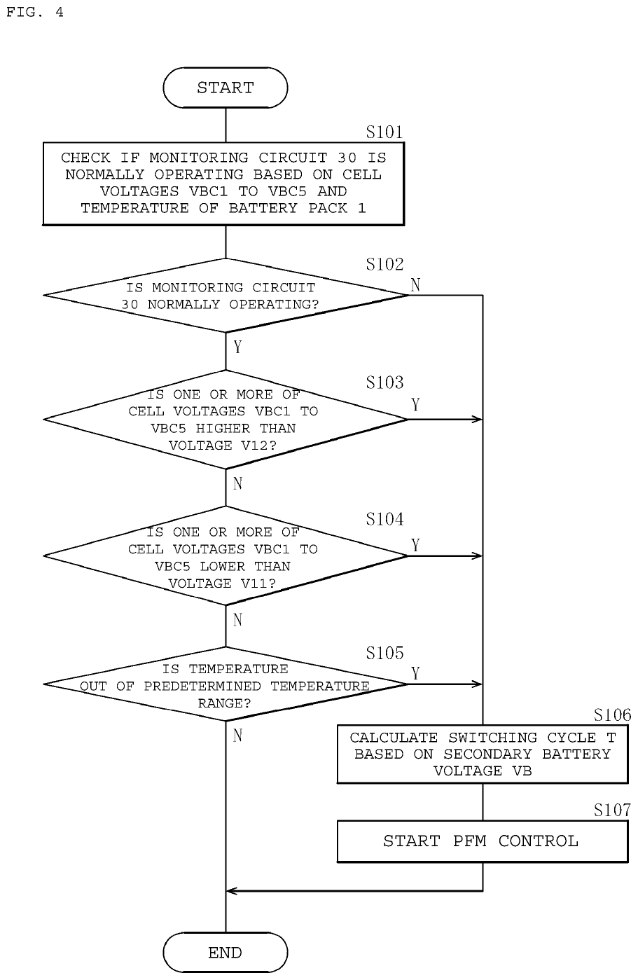

FIG. 4 shows an operation example of the control circuit 12.

First, the control circuit 12 checks if the monitoring circuit 30 is normally operating based on the cell voltages VBC1 to VBC5 and the temperature of the secondary battery 11 (step S101). Specifically, the control circuit 12 determines that the monitoring circuit 30 is not normally operating, for example, when each of the cell voltages VBC1 to VBC5 is a voltage outside the assumed voltage range or when the temperature of the secondary battery 11 is a temperature outside the assumed temperature range. When the monitoring circuit 30 is not operating normally (“N” in step S102), the process proceeds to step S106.

In step S101, when the monitoring circuit 30 is operating normally (“Y” in step S102), the control circuit 12 checks if one or more of the cell voltages VBC1 to VBC5 is higher than the voltage V12 (for example, 4.3 V) (step S103). In other words, the control circuit 12 checks if one or more of the battery cells BC1 to BC5 is in the overcharged state S3 based on the cell voltages VBC1 to VBC5. When one or more of the cell voltages VBC1 to VBC5 is higher than the voltage V12 (“Y” in step S103), the process proceeds to step S106.

In step S103, when all of the cell voltages VBC1 to VBC5 are the voltage V12 or less (“N” in step S103), the control circuit 12 checks if one or more of the cell voltages VBC1 to VBC5 is lower than the voltage V11 (for example, 1.5 V) (step S104). In other words, the control circuit 12 checks if one or more of the battery cells BC1 to BC5 is in the overdischarged state S1 based on the cell voltages VBC1 to VBC5. When one or more of the cell voltages VBC1 to VBC5 is lower than the voltage V11 (“Y” in step S104), the process proceeds to step S106.

In step S104, when all of the cell voltages VBC1 to VBC5 are equal to or higher than the voltage V11 (“N” in step S103), the control circuit 12 checks if the temperature of the secondary battery 11 is out of the predetermined temperature range (step S105). The predetermined temperature range is a normal operating temperature range of the battery pack 1. For example, when the battery pack 1 generates heat due to an operation abnormality, the temperature of the secondary battery 11 can be higher than the predetermined temperature range. When the temperature of the secondary battery 11 is out of the predetermined temperature range (“Y” in step S105), the process proceeds to step S106.

In step S105, when the temperature of the secondary battery 11 is within the predetermined temperature range (“N” in step S105), the process ends.

The control circuit 12 calculates the switching cycle T based on the secondary battery voltage VB (step S106), when the monitoring circuit 30 is not operating normally (“N” in step S102), when one or more of the cell voltages VBC1 to VBC5 is higher than the voltage V12 (“Y” in step S103), when one or more of the cell voltages VBC1 to VBC5 is lower than the voltage V11 (“Y” in step S104), or when the temperature of the secondary battery 11 is out of the predetermined temperature range (“Y” in step S105). Specifically, for example, when the secondary battery voltage VB is high, the control circuit 12 increases the OFF time Toff while maintaining the ON time Ton, thereby increasing the switching cycle T. In addition, for example, when the secondary battery voltage VB is low, the control circuit 12 decreases the OFF time Toff while maintaining the ON time Ton, thereby decreasing the switching cycle T.

Then, the control circuit 12 starts the PFM control using the switching cycle T calculated in step S106 (step S107). In this way, the control circuit 12 generates the control signal CTL as shown in FIG. 3.

By the above, this process ends.

Next, how to set the following parameters in the PFM control will be described in further detail according to an embodiment.
(1) Voltage range W of secondary battery voltage VB
(2) ON time Ton
(3) Switching cycle T and melting and cutting time Tf

### (1) Voltage Range W of Secondary Battery Voltage VB

The control circuit 12 performs PFM control based on the secondary battery voltage VB. First, the voltage range W of the secondary battery voltage VB is set.

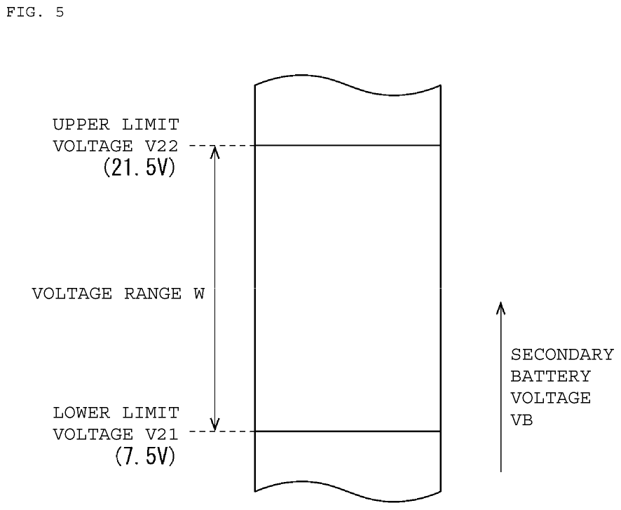

FIG. 5 illustrates an example of the secondary battery voltage VB. The voltage range W of the secondary battery voltage VB is set by considering how high the secondary battery voltage VB can be based on the characteristics of the battery cell BC illustrated in FIG. 2. In this example, the lower limit voltage V21 of the voltage range W of the secondary battery voltage VB is set to 7.5 [V], and the upper limit voltage V22 is set to 21.5 [V]. The lower limit voltage V21 (7.5 [V]) is estimated on the assumption that all the cell voltages VBC of the five battery cells BC are the voltage V11 (1.5 [V]), and the upper limit voltage V22 (21.5 [V]) is estimated on the assumption that all the cell voltages VBC of the five battery cells BC are the voltage V12 (4.3 [V]). The lower limit voltage V21 and the upper limit voltage V22 are not limited thereto and can be appropriately set. The control circuit 12 generates the control signal CTL when the secondary battery voltage VB is equal to or higher than the lower limit voltage V21 and equal to or lower than the upper limit voltage V22.

For example, when one or more of the battery cells BC1 to BC5 in the secondary battery 11 is in the overcharged state S3, the secondary battery voltage VB can be a high voltage within the voltage range W. When one or more of the battery cells BC1 to BC5 in the secondary battery 11 is in the overdischarged state S1, the secondary battery voltage VB can be a low voltage within the voltage range W. For example, when the temperature of the secondary battery 11 is outside the predetermined temperature range or when the monitoring circuit 30 is not operating normally, the secondary battery voltage VB can be any voltage within the voltage range W. The voltage range W of the secondary battery voltage VB is set to such a voltage range that the secondary battery voltage VB falls within the voltage range W in such various situations.

### (2) ON Time Ton

In the ON time Ton, power is applied to the heat generator 22, and the heat generator 22 generates heat. If the ON time Ton is too long, for example, the resistance value of the heat generator 22 increases due to stress, and the heat generator 22 may fail. Therefore, assuming the voltage range W (FIG. 5) of the secondary battery voltage VB, experiments were conducted to check the time (failure time) until the heat generator 22 fails by applying various DC voltages from 13.3 [V] to 21.5 [V] to the heat generator 22.

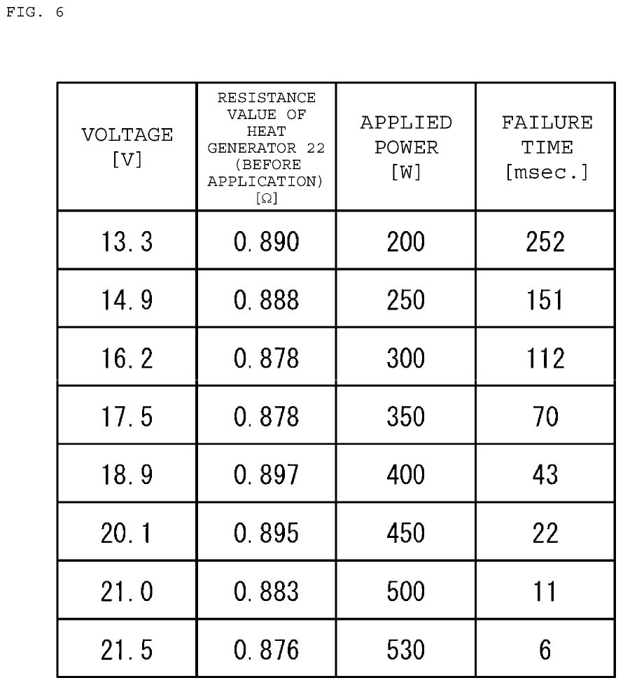

FIGS. 6 and 7 show examples of experimental results of the failure time. Here, the applied power is power applied to the heat generator, and is power calculated based on the voltage applied to the heat generator 22 and the resistance value of the heat generator 22 before the voltage is applied. For example, the applied power is 530 [W] when a voltage of 21.5 [V] is applied to the heat generator 22. In this example, when the resistance value of the heat generator 22 increases and the fuse element 21 is not melted and cut when a voltage is applied to the heat generator 22 for a predetermined time, it is determined that the heat generator 22 has failed.

As illustrated in FIGS. 6 and 7, the more the applied power increases, the more applied stress the heat generator 22 has. Therefore, the failure time becomes shorter and the heat generator 22 fails in a short time. For example, the failure time is 6 [msec.] when a voltage of 21.5 [V] is applied to the heat generator 22. This result indicates that the ON time Ton should be at least 6 [msec.] or less in the case of performing the PFM control. In this example, the ON time Ton is set using the following equation EQ1 in consideration of a margin.

On time Ton=failure time×rated power/applied power (EQ1)

Here, the rated power is the rated power of the heat generator 22, and is 100 [W] in this example. For example, when the applied power is 530 [W], the rated power is 100 [W], and the failure time is 6 [msec.], the ON time Ton is 1 [sec.]. Therefore, in this example, the ON time Ton is set to 1 [sec.].

### (3) Switching Cycle T and Melting and Cutting Time Tf

In the PFM control, as illustrated in FIG. 3, power is applied to the heat generator 22 at the ON time Ton, and no power is applied at the OFF time Toff. Therefore, the power applied to the heat generator 22 is adjusted through the duty ratio of the control signal CTL.

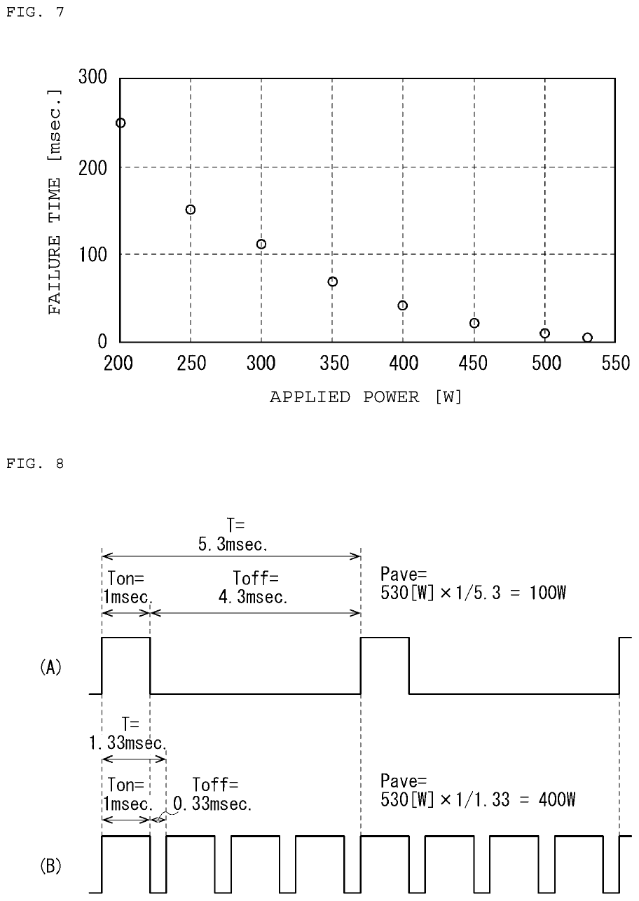

FIG. 8 illustrates an example of the control signal CTL in a case where a voltage of 21.5 [V] is applied to the heat generator 22. As illustrated in FIG. 6, when a voltage of 21.5 [V] is applied to the heat generator 22, the applied power is 530 [W]. FIG. 8 (A) illustrates a waveform example in a case where the power applied to the heat generator 22 in the period of the switching cycle T (hereinafter, also referred to as intra-cycle average power Pave) is set to 100 [W], and FIG. 8 (B) illustrates a waveform example in a case where the intra-cycle average power Pave is set to 400 [W].

When the intra-cycle average power Pave is set to 100 [W], the duty ratio is set to 18.9% (=1/5.3) as illustrated in FIG. 8 (A). That is, since the applied power is 530 [W], the intra-cycle average power Pave can be set to 100 [W] (=530 [W]×1/5.3). Since the ON time Ton is fixed to 1 [msec.], the OFF time Toff is 4.3 [msec.], and the switching cycle T is 5.3 [msec.]. As described above, when the duty ratio is 18.9%, the intra-cycle average power Pave can be equal to the rated power (100 [W]) of the heat generator 22.

When the intra-cycle average power Pave is set to 400 [W], the duty ratio is set to 75.2% (=1/1.33) as illustrated in FIG. 8 (B). That is, since the applied power is 530 [W], the intra-cycle average power Pave can be set to 400 [W] (=530 [W]×1/1.33). Since the ON time Ton is fixed to 1 [msec.], the OFF time Toff is 0.33 [msec.], and the switching cycle T is 1.33 [msec.].

FIG. 9 shows an example of the experimental result of the melting and cutting time Tf of the fuse element 21 when the intra-cycle average power Pave is changed from 100 [W] to 450 [W]. For example, when the intra-cycle average power Pave is 100 [W], the switching cycle T is 5.3 [msec.], and the melting and cutting time Tf is 430 [msec.]. For example, when the intra-cycle average power Pave is 400 [W], the switching cycle T is 1.33 [msec.], and the melting and cutting time Tf is 110 [msec.]. As described above, as the intra-cycle average power Pave increases, the melting and cutting time Tf decreases. That is, the shorter the switching cycle T, the shorter the melting and cutting time Tf.

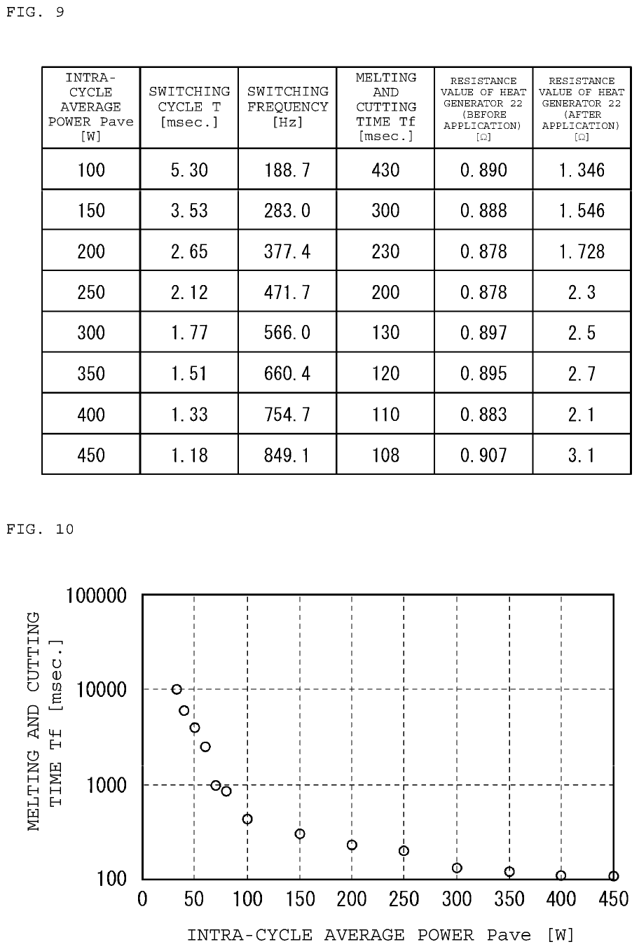

FIG. 10 shows an example of the experimental result of the melting and cutting time Tf when the intra-cycle average power Pave is changed from 30 [W] to 450 [W]. For example, when the intra-cycle average power Pave decreases, the melting and cutting time Tf increases more rapidly. The heat from the heat generator 22 is transferred not only to the fuse element 21 but also to a substrate pattern, a cell tab, a bus bar, and the like, around the protection circuit 20. For example, when the melting and cutting time Tf becomes 1 [sec.] or more, the melting and cutting time Tf becomes longer due to the influence of the heat capacity of the substrate pattern, the cell tab, and the bus bar. Therefore, in this example, the melting and cutting time Tf is set to be within 1 [sec.].

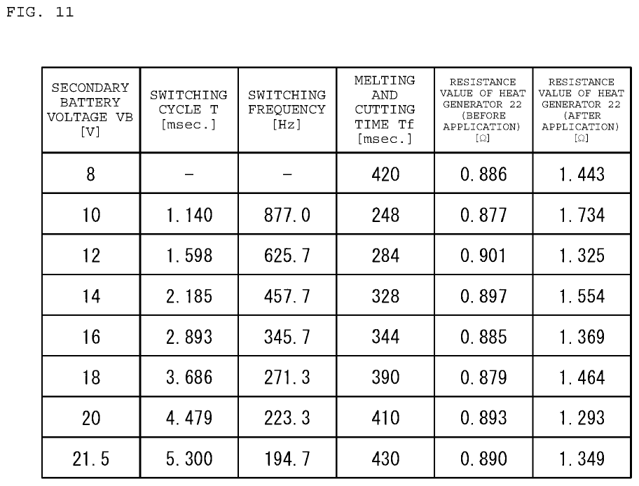

FIG. 11 shows an example of the setting of the switching cycle T according to the secondary battery voltage VB. This example shows the switching cycle T in the voltage range W (FIG. 5) of the secondary battery voltage VB. When the secondary battery voltage VB is 8.9 [V] or less, the applied power is smaller than the rated power of the heat generator 22 if the voltage is continuously applied. Therefore, the PFM control is not performed. Therefore, when the secondary battery voltage VB is 8 [V], the switching cycle T and the switching frequency are indicated by “-”. When the PFM control is performed, the switching cycle T is calculated using the following equation EQ2.

Switching cycle T=(secondary battery voltage VB)²/resistance value of heat generator 22/intra-cycle average power Pave×ON time Ton (EQ2)

When the secondary battery voltage VB is 8 [V], the melting and cutting time Tf is 420 [msec.]. In addition, in the voltage range where the secondary battery voltage VB is 10 [V] to 21.5 [V], in which the PFM control is performed, the melting and cutting time Tf becomes longer as the secondary battery voltage VB becomes higher. The melting and cutting time Tf falls within 1 [sec.] in the whole voltage range W of the secondary battery voltage VB. Therefore, in this example, the control circuit 12 can perform the PFM control using the switching cycle T listed in FIG. 11.

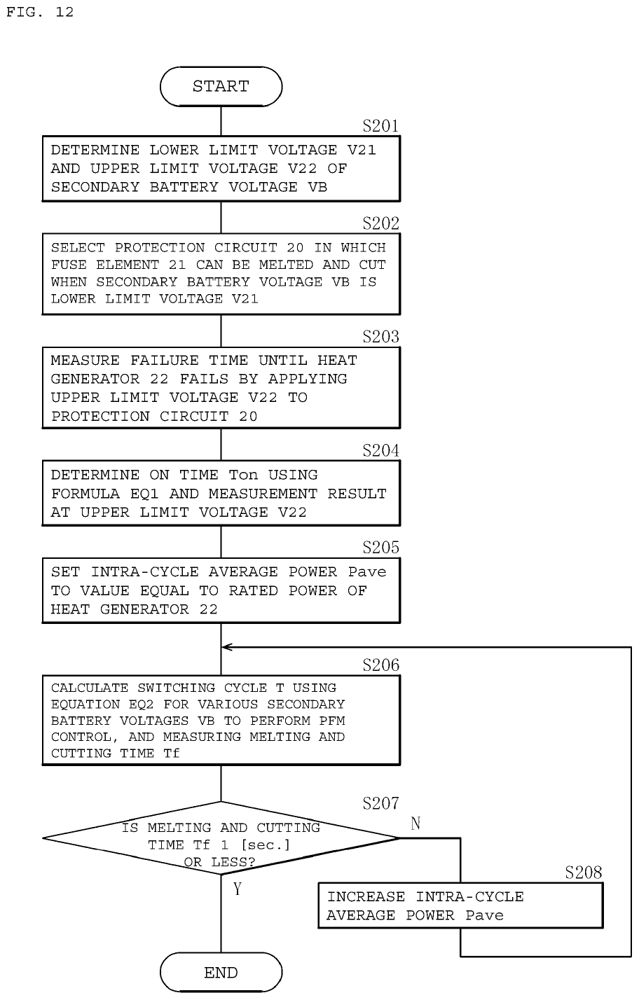

FIG. 12 shows an example of the procedure for setting the PFM control parameters. For example, an engineer who develops the battery pack 1 can set the PFM control parameters according to this procedure.

First, as described in (1) above, the engineer determines the lower limit voltage V21 and the upper limit voltage V22 of the secondary battery voltage VB (step S201).

Next, the engineer selects the protection circuit 20 in which the fuse element 21 can be melted and cut when the secondary battery voltage VB is the lower limit voltage V21 (step S202). That is, when the secondary battery voltage VB is low, the power applied to the heat generator 22 decreases, and thus the heat generator 22 may not be able to provide heat to the fuse element 21 to such an extent that the fuse element 21 can be melted and cut. Therefore, the engineer selects the protection circuit 20 in which the fuse element 21 can be melted and cut when the secondary battery voltage VB is the lower limit voltage V21.

Next, as described in (2) above, the engineer applies the upper limit voltage V22 to the protection circuit 20, measures the failure time until the heat generator 22 fails (step S203), and determines the ON time Ton using the formula EQ1 and the measurement result at the upper limit voltage V22 (step S204).

Next, as described in (3) above, the engineer sets the intra-cycle average power Pave to a value equal to the rated power of the heat generator 22 (step S205), calculates the switching cycle T using the equation EQ2 for various secondary battery voltages VB to perform the PFM control, and measures the melting and cutting time Tf (step S206).

Next, the engineer checks if all the melting and cutting times Tf measured in step S206 are within 1 [sec.] (step S207). When there is data in which the melting and cutting time Tf is longer than 1 [sec.] (“N” in step S207), the engineer sets the intra-cycle average power Pave to a higher value (step S208). The process returns to step S206. The engineer repeats the process of steps S206 to S208 until all the melting and cutting times Tf are within 1 [sec.].

When all the melting and cutting times Tf are within 1 [sec.] (“Y” in step S207), this procedure ends.

The engineer determines various parameters used in the PFM control by this procedure. Then, for example, the engineer mounts the equation EQ2 on the control circuit 12 such that the control circuit 12 calculates the switching cycle T based on the secondary battery voltage VB using the equation EQ2. In the equation EQ2, the resistance value of the heat generator 22, the intra-cycle average power Pave, and the ON time Ton are fixed values. Therefore, the switching cycle T can be expressed by the following equation EQ3 using the constant C.

$$Switching cycle T = C \times {( secondary battery voltage VB )}^{2} \qquad ( EQ3 )$$

Here, the constant C is represented by the following equation EQ4.

$$C = ON time Ton / resistance value of \\ heat generator 22 / intra - cycle average power Pave \qquad ( EQ4 )$$

In this example, the control circuit 12 calculates the switching cycle T on the basis of the secondary battery voltage VB using the equation EQ2, but is not limited thereto. Alternatively, for example, the control circuit 12 may store a lookup table indicating the relationship between the secondary battery voltage VB and the switching cycle T calculated on the basis of the equation EQ2, and calculate the switching cycle T on the basis of the secondary battery voltage VB using the lookup table.

When it is required to stop using the battery pack 1, the control circuit 12 performs the PFM control based on the secondary battery voltage VB and thereby generates a control signal CTL. The control circuit 12 controls the switching operation of the transistor 13 by using the control signal CTL. As a result, for example, as compared with a case where pulse width modulation (PWM) control is performed, the heat generator 22 is less likely to fail, thereby surely melting and cutting the fuse element 21. The comparison between the PFM control and the PWM control will be described below.

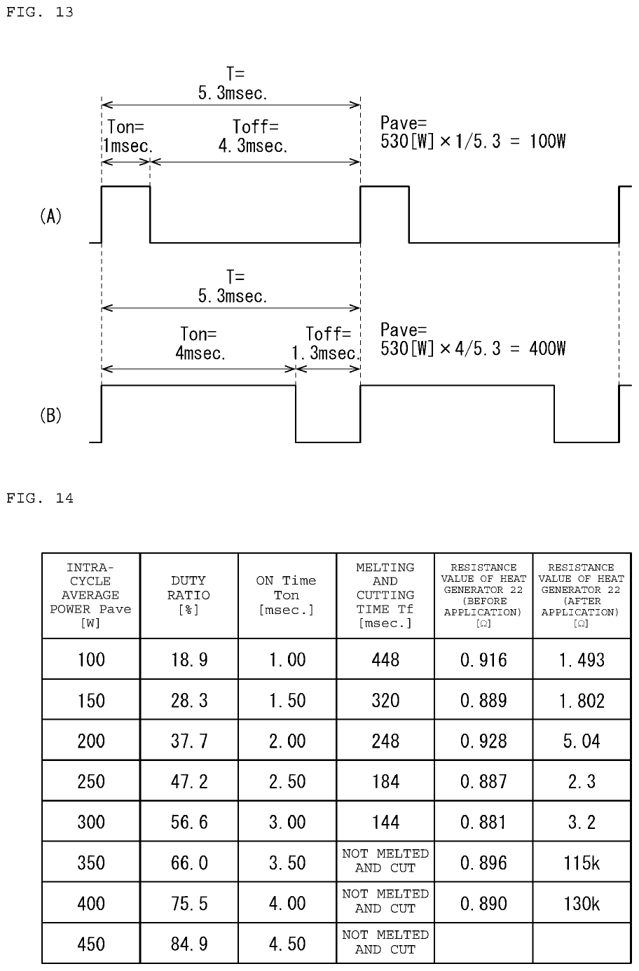

FIG. 13 illustrates an example of the control signal CTL when PWM control is performed. In this example, similarly to the PFM control (FIG. 8), a voltage of 21.5 [V] is applied to the heat generator 22. FIG. 13 (A) illustrates a waveform example in a case where the intra-cycle average power Pave is set to 100 [W], and FIG. 13 (B) illustrates a waveform example in a case where the intra-cycle average power Pave is set to 400 [W].

When the intra-cycle average power Pave is set to 100 [W], the duty ratio is set to 18.9% (=1/5.3) as illustrated in FIG. 13 (A). That is, since the applied power is 530 [W], the intra-cycle average power Pave can be set to 100 [W] (=530 [W]×1/5.3). Similarly to the PFM control (FIG. 8), when the switching cycle is 5.3 [msec.], the ON time Ton is 1 [msec.], and the OFF time Toff is 4.3 [msec.]. The waveform of FIG. 13 (A) is the same as the waveform of FIG. 8 (A).

When the intra-cycle average power Pave is set to 400 [W], the duty ratio is set to 75.2% (=1/1.33) as illustrated in FIG. 13 (B). That is, since the applied power is 530 [W], the intra-cycle average power Pave can be set to 400 [W] (=530 [W]×1/1.33). Since the switching cycle is fixed to 5.3 [msec.], the ON time Ton is 4 [msec.], and the OFF time Toff is 1.3 [msec.]. FIG. 13 (B) is a waveform into which the four pulses in the waveform of FIG. 8 (B) are integrated. That is, in the PFM control (FIG. 8 (B)), power is applied to the heat generator 22 using four pulses, but in the PWM control (FIG. 13 (B)), power is collectively applied to the heat generator 22 using one pulse.

FIG. 14 shows an example of the experimental result of the melting and cutting time Tf of the fuse element 21 when the intra-cycle average power Pave is changed from 100 [W] to 450 [W]. FIG. 14 corresponds to FIG. 9, which indicates the PFM control. For example, when the intra-cycle average power Pave is 100 [W], the ON time Ton is 1 [msec.], and the melting and cutting time Tf is 448 [msec.]. Similarly to the PFM control, as the intra-cycle average power Pave increases, the melting and cutting time Tf decreases.

However, when the intra-cycle average power Pave is 350 [W] or more in the PWM control, for example, the heat generator 22 has an increased resistance value and fails, thereby the fuse element 21 is not fused. For example, when power of 400 [W] is continuously applied to the heat generator 22 as shown in FIG. 6, the failure time is 43 [msec.]. In the example of FIG. 13 (B), the ON time Ton is 4 [msec.], but the heat generator 22 fails. This is presumably because damage to the heat generator 22 is accumulated by repeated pulses in the PWM control.

As described above, in the PWM control, as illustrated in FIG. 14, the heat generator 22 fails in a case where the intra-cycle average power Pave is 350 [W] or more. On the other hand, in the PFM control, as illustrated in FIG. 9, the heat generator 22 does not fail, and the fuse element 21 can be melted and cut in a case where the intra-cycle average power Pave is 350 [W] or more. For example, comparing the waveform of the control signal CTL in the PFM control (FIG. 8(B)) and the waveform of the control signal CTL in the PWM control (FIG. 13(B)) in a case where the intra-cycle average power Pave is 400 [W], the intra-cycle average power Pave is the same, but the ON time Ton is different. That is, this is presumably because the PEM control (FIG. 8(B)) frequently repeats ON/OFF as compared with the PWM control (FIG. 13(B)) and therefore less damage accumulates.

As described above, when the PFM control is performed, the heat generator 22 is less likely to fail and can surely melt and cut the fuse element 21, as compared with a case where the PWM control is performed.

As described above, the battery pack 1 includes: the secondary battery 11 provided on a path connecting the positive electrode EP and the negative electrode EN and having five battery cells BC1 to BC5 connected in series; the monitoring circuit 30 capable of detecting the cell voltage VBC of each of the five battery cells BC1 to BC5; the positive terminal TP led to the positive electrode EP via the first path (power supply line PL1); the negative terminal TN led to the negative electrode EN via the second path (power supply line PL2); the fuse element 21 provided on the first path (power supply line PL1) and configured to be melted and cut due to heat; the heat generator 22 provided on a third path connecting the first path (power supply line PL1) and the second path (power supply line PL2) and capable of generating heat to melt and cut the fuse element 21; the transistor 13 provided on the third path; and the control circuit 12 capable of controlling a switching operation of the transistor 13 based on a detection result of the monitoring circuit 30, by performing PFM control such that the transistor 13 has the ON time Ton that is kept at a predetermined time and the transistor 13 has the OFF time Toff that can be changed according to the secondary battery voltage VB, which is a voltage between both terminals of the secondary battery 11. As a result, for example, the power applied to the heat generator 22 can be adjusted according to the secondary battery voltage VB, so that the fuse element 21 can be melted and cut according to the various secondary battery voltages VB. As a result, the charge/discharge path can be cut off in various states where the battery pack should not be used.

That is, for example, in the technique described in Japanese Patent Application Laid-Open No. 2015-53780, the fuse element can be melted and cut when the secondary battery voltage VB is high, but it is difficult to melt and cut the fuse element when the secondary battery voltage VB is low. On the other hand, in the battery pack 1, the transistor 13 has an OFF time Toff that is changed according to the secondary battery voltage VB. For example, the control circuit 12 can set the OFF time Toff to a first time when the secondary battery voltage VB is a first voltage and can set the OFF time Toff to a second time that is longer than the first time when the secondary battery voltage VB is a second voltage that is higher than the first voltage. Thus, in the battery pack 1, for example, the fuse element 21 can be melted and cut when the secondary battery voltage VB is low. As a result, in the battery pack 1, the charge/discharge path can be cut off in various states where the battery pack should not be used.

The battery pack 1 performs the PFM control. Therefore, for example, as compared with a case where the PWM control is performed, the heat generator 22 is less likely to fail, thereby surely melt and cut the fuse element 21.

In the battery pack 1, the control circuit 12 can perform the PFM control when one or more of the five cell voltages VBC1 to VBC5 is higher than the first threshold voltage (voltage V12). The control circuit 12 can perform the PFM control when one or more of the five cell voltages VBC1 to VBC5 is lower than the second threshold voltage (voltage V11). The monitoring circuit 30 detects the temperature of the secondary battery 11, and the control circuit 12 can perform the PFM control when the temperature of the secondary battery 11 is out of the predetermined temperature range. The control circuit 12 can further determine if the monitoring circuit 30 is normally operating based on the detection result of the monitoring circuit 30, and can perform the PFM control when the monitoring circuit 30 is not normally operating. As described above, in the battery pack 1, the charge/discharge path can be cut off in various states where the battery pack should not be used.

The battery pack 1 has a melting and cutting time Tf of within 1 second, the melting and cutting time being after the control circuit 12 starts the PFM control and before the fuse element 21 is melted and cut. As a result, the substrate pattern, the cell tab, and the bus bar around the protection circuit 20 has less influence on the melting and cutting time Tf, and the melting and cutting time Tf can be short.

As described above, in an embodiment, the present disclosure provides: a secondary battery provided on a path connecting a positive electrode and a negative electrode and having five battery cells connected in series; the monitoring circuit capable of detecting the cell voltage of each of the five battery cells; a positive terminal led to the positive electrode via a first path; a negative terminal led to the negative electrode via a second path; a fuse element provided on the first path and configured to be melted and cut due to heat; a heat generator provided on a third path connecting the first path and the second path and capable of generating heat to melt and cut the fuse element; a transistor provided on the third path; and a control circuit capable of controlling the switching operation of the transistor based on the detection result of the monitoring circuit, by performing PFM control such that the transistor has an ON time that is kept at a predetermined time and the transistor has an OFF time that can be changed according to a secondary battery voltage, which is a voltage between both terminals of the secondary battery. As a result, the charge/discharge path can be cut off in various states where the battery pack should not be used.

In an embodiment, since the PFM control is performed, it is possible to more reliably melt and cut the fuse element as compared with the case of performing the PWM control, for example.

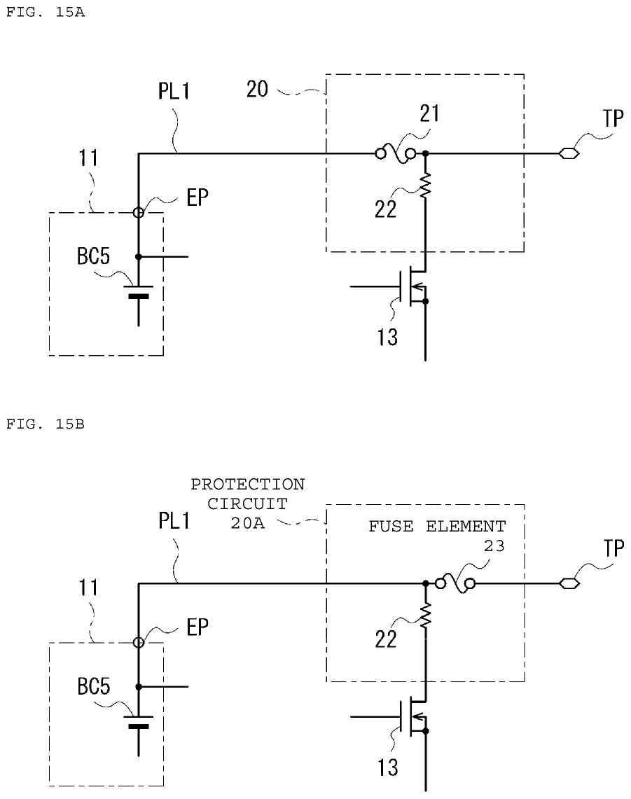

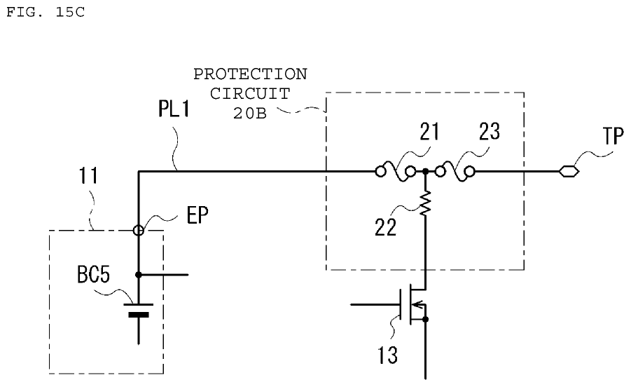

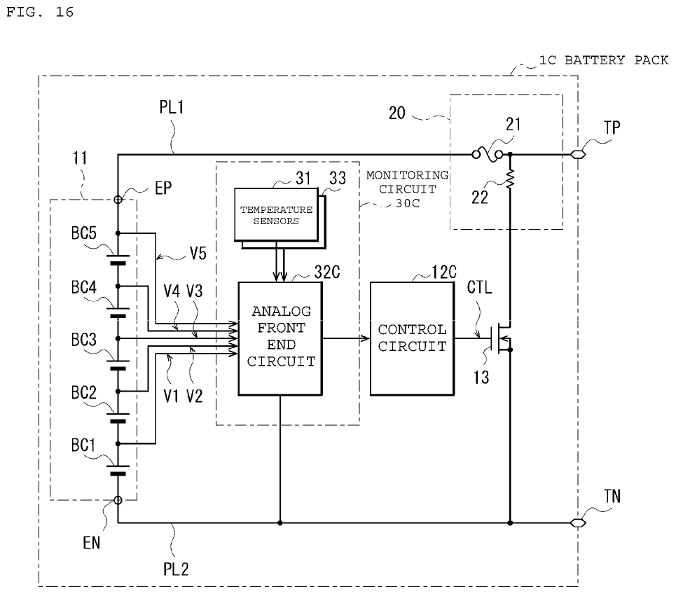

In an embodiment, as illustrated in FIG. 15A, the protection circuit 20 including the fuse element 21 and the heat generator 22 is provided, but the present disclosure is not limited thereto. Alternatively, for example, as illustrated in FIG. 15B, a protection circuit 20A including a fuse element 23 and a heat generator 22 may be provided. One end of the fuse element 23 is connected to the positive electrode EP of the secondary battery 11 and one end of the heat generator 22, and the other end of the fuse element 23 is connected to the positive terminal TP of the battery pack 1. Alternatively, for example, as illustrated in FIG. 15C, a protection circuit 20B including a fuse element 21 and 23 and a heat generator 22 may be provided. One end of the fuse element 21 is connected to the positive electrode EP of the secondary battery 11, and the other end of the fuse element 21 is connected to one end of the heat generator 22 and one end of the fuse element 23. One end of the fuse element 23 is connected to the other end of the fuse element 21 and one end of the heat generator 22, and the other end is connected to the positive terminal TP of the battery pack 1.

In an embodiment, one temperature sensor 31 is provided, but the present disclosure is not limited thereto. Alternatively, for example, a plurality of temperature sensors may be provided as in a battery pack 1C illustrated in FIG. 16. The battery pack 1C includes a monitoring circuit 30C and a control circuit 12C. The monitoring circuit 30C includes temperature sensors 31 and 33 and an analog front end circuit 32C. In this example, the temperature sensor 33 is provided on a substrate (not illustrated), and is configured to detect the temperature of the substrate. Then, the temperature sensor 33 provides a detection result to the analog front end circuit 32C. The analog front end circuit 32C is configured to provide detection results of the cell voltages VBC1 to VBC5 and detection results of the temperature sensors 31 and 33 to the control circuit 12C. The control circuit 12C makes a decision to stop using the battery pack 1C, for example, when the temperature of the substrate is out of a predetermined temperature range.

In an embodiment, the control circuit 12 makes a decision to stop using the battery pack 1, for example, when one or more of the battery cells BC1 to BC5 in the secondary battery 11 is in the overcharged state S3, when one or more of the battery cells BC1 to BC5 in the secondary battery 11 is in the overdischarged state S1, when the temperature of the secondary battery 11 is out of a predetermined temperature range, or when the monitoring circuit 30 is not normally operating, but the present disclosure is not limited thereto. The case where it is required to stop using the battery pack 1 is not limited to the four cases. It is possible to lack some of the four cases, or it is possible to include other cases.

Further, two or more of the modifications may be combined according to an embodiment.

Although the present technique is described with reference to the embodiments, the present technique is not limited to these embodiments and the like, and various modifications can be made.

For example, in an embodiment, the five battery cells BC are provided as illustrated in FIG. 1, but the present disclosure is not limited thereto. It is possible to provide 4 or less battery cells BC or 6 or more battery cells.

Since the effects described in the present specification are merely examples, the effects of the present disclosure are not limited to the effects described in the present specification. Thus, other effects regarding the present disclosure may be obtained.

The present disclosure includes the following aspects according to an embodiment.

<1>

A battery pack including:
a secondary battery provided on a path connecting a first terminal and a second terminal and having a plurality of battery cells connected in series;
a monitoring circuit capable of detecting a cell voltage of each of the plurality of battery cells;
a first connection terminal led to the first terminal via a first path;
a second connection terminal led to the second terminal via a second path;
a fuse element provided on the first path and configured to be melted and cut due to heat;
a heat generator provided on a third path connecting the first path and the second path and capable of generating heat to melt and cut the fuse element;
a switch element provided on the third path; and
a control circuit capable of controlling a switching operation of the switch element based on a detection result of the monitoring circuit, by performing PFM control such that the switch element has an ON time that is kept at a predetermined time and the switch element has an OFF time that can be changed according to a secondary battery voltage, which is a voltage between both terminals of the secondary battery.
   <2>

The battery pack according to <1>, wherein the control circuit can set the OFF time to a first time when the secondary battery voltage is a first voltage and can set the OFF time to a second time that is longer than the first time when the secondary battery voltage is a second voltage that is higher than the first voltage.

<3>

The battery pack according to <1> or <2>, wherein the control circuit can perform the PFM control when one or more of the plurality of cell voltages is higher than a first threshold voltage.

<4>

The battery pack according to <3>, wherein the control circuit can further perform the PFM control when one or more of the plurality of cell voltages is lower than a second threshold voltage, and the second threshold voltage is lower than the first threshold voltage.

<5>

The battery pack according to <1> or <2>, wherein the control circuit can perform the PFM control when one or more of the plurality of cell voltages is lower than a second threshold voltage.

<6>

The battery pack according to any one of <1> to <4>, wherein the monitoring circuit can further detect a temperature of the secondary battery, and the control circuit can further perform the PFM control when the secondary battery has a temperature that is out of a predetermined temperature range.

<7>

The battery pack according to any one of <1> to <4>, wherein the control circuit can further determine if the monitoring circuit is normally operating based on a detection result of the monitoring circuit, and can perform the PFM control when the monitoring circuit is not normally operating.

<8>

The battery pack according to any one of <1> to <7>, having a melting and cutting time of within 1 second, the melting and cutting time being a time after the control circuit starts the PFM control and before the fuse element is melted and cut.

<9>

The battery pack according to any one of <1> to <8>, wherein the control circuit can perform the PFM control by calculating a switching cycle T of the switch element based on a voltage value V of the secondary battery voltage using the following equation (1):

$$T = C \times {V}^{2} , \qquad ( 1 )$$

wherein C is a predetermined constant.
   <10>

The battery pack according to any one of <1> to <8>, wherein
the control circuit can perform the PFM control by using table data indicating a relationship between a voltage value V of the secondary battery voltage and a switching cycle T of the switch element to calculate the switching cycle T based on the voltage value V of the secondary battery voltage, the relationship being calculated using the following equation (1):

$$T = C \times {V}^{2} . \qquad ( 1 )$$

<11>

A method for controlling a battery pack, the battery pack including: a secondary battery provided on a path connecting a first terminal and a second terminal and having a plurality of battery cells connected in series; a first connection terminal led to the first terminal via a first path; a second connection terminal led to the second terminal via a second path; a fuse element provided on the first path and configured to be melted and cut due to heat; a heat generator provided on a third path connecting the first path and the second path and capable of generating heat to melt and cut the fuse element; and a switch element provided on the third path, and
the method including:
detecting a cell voltage of each of the plurality of battery cells; and
controlling an operation of the switch element based on a plurality of the detected cell voltages by performing PFM control such that the switch element has an ON time that is kept at a predetermined time and has an OFF time that can be changed according to a secondary battery voltage, which is a voltage between both terminals of the secondary battery.

1. A battery pack comprising:
a secondary battery provided on a path connecting a first terminal and a second terminal and having a plurality of battery cells connected in series;
a monitoring circuit capable of detecting a cell voltage of each of the plurality of battery cells;
a first connection terminal led to the first terminal via a first path;
a second connection terminal led to the second terminal via a second path;
a fuse element provided on the first path and configured to be melted and cut due to heat;
a heat generator provided on a third path connecting the first path and the second path and capable of generating heat to melt and cut the fuse element;
a switch element provided on the third path; and
a control circuit capable of controlling a switching operation of the switch element based on a detection result of the monitoring circuit, by performing PFM control such that the switch element has an ON time that is kept at a predetermined time and the switch element has an OFF time that can be changed according to a secondary battery voltage, which is a voltage between both terminals of the secondary battery.

2. The battery pack according to claim 1, wherein
the control circuit
can set the OFF time to a first time when the secondary battery voltage is a first voltage and
can set the OFF time to a second time that is longer than the first time when the secondary battery voltage is a second voltage that is higher than the first voltage.

3. The battery pack according to claim 1, wherein
the control circuit can perform the PFM control when one or more of the plurality of cell voltages is higher than a first threshold voltage.

4. The battery pack according to claim 3, wherein
the control circuit can further perform the PFM control when one or more of the plurality of cell voltages is lower than a second threshold voltage, and the second threshold voltage is lower than the first threshold voltage.

5. The battery pack according to claim 1, wherein
the control circuit can perform the PFM control when one or more of the plurality of cell voltages is lower than a second threshold voltage.

6. The battery pack according to claim 1, wherein
the monitoring circuit can further detect a temperature of the secondary battery, and
the control circuit can further perform the PFM control when the secondary battery has a temperature that is out of a predetermined temperature range.

7. The battery pack according to claim 1, wherein
the control circuit can further determine if the monitoring circuit is normally operating based on a detection result of the monitoring circuit, and can perform the PFM control when the monitoring circuit is not normally operating.

8. The battery pack according to claim 1, having
a melting and cutting time of within 1 second, the melting and cutting time being a time after the control circuit starts the PFM control and before the fuse element is melted and cut.

9. The battery pack according to claim 1, wherein
the control circuit can perform the PFM control by calculating a switching cycle T of the switch element based on a voltage value V of the secondary battery voltage using the following equation (1):
$$T = C \times {V}^{2} , \qquad ( 1 )$$
wherein C is a predetermined constant.

10. The battery pack according to claim 1, wherein
the control circuit can perform the PFM control by using table data indicating a relationship between a voltage value V of the secondary battery voltage and a switching cycle T of the switch element to calculate the switching cycle T based on the voltage value V of the secondary battery voltage, the relationship being calculated using the following equation (1):
$$T = C \times {V}^{2} . \qquad ( 1 )$$

11. A method for controlling a battery pack, the battery pack including: a secondary battery provided on a path connecting a first terminal and a second terminal and having a plurality of battery cells connected in series; a first connection terminal led to the first terminal via a first path; a second connection terminal led to the second terminal via a second path; a fuse element provided on the first path and configured to be melted and cut due to heat; a heat generator provided on a third path connecting the first path and the second path and capable of generating heat to melt and cut the fuse element; and a switch element provided on the third path, and
the method comprising:
detecting a cell voltage of each of the plurality of battery cells; and
controlling an operation of the switch element based on a plurality of the detected cell voltages by performing PFM control such that the switch element has an ON time that is kept at a predetermined time and has an OFF time that can be changed according to a secondary battery voltage, which is a voltage between both terminals of the secondary battery.
